(19) United States
(12) Patent Application Publication
(10) Pub. No.: US 2025/0209296 A1
(43) Pub. Date: Jun. 26, 2025

(54) Systems and Methods for Simulating Brain-Computer Interfaces

(71) Applicant: The Regents of the University of California, Oakland, CA (US)

(72) Inventors: Jonathan Kao, Los Angeles, CA (US); Ken-Fu Liang, Oakland, CA (US)

(73) Assignee: The Regents of the University of California, Oakland, CA (US)

(21) Appl. No.: 18/848,107

(22) PCT Filed: Mar. 17, 2023
(86) PCT No.: PCT/US2023/064642

§ 371 Date: Sep. 17, 2024

Related U.S. Application Data
(60) Provisional application No. 63/269,534, filed on Mar. 17, 2022.

(51) Int. Cl. G06N 3/006; G06N 3/063

(52) U.S. Cl. CPC G06N 3/006; G06N 3/063

(57) ABSTRACT

Systems and methods for simulating brain-computer interfaces (BCIs) are described. In many embodiments, BCI decoders can be evaluated entirely in silico. Neural encoders are used to generate synthetic neural signals that mimic real neural signals for a given activity. Artificial intelligence agents emulate user control policies which can be used to guide the generation of the synthetic neural signals. Closed-loop testing can be achieved by providing a simulated testing environment.

### CROSS-REFERENCE TO RELATED APPLICATIONS

The current application claims the benefit of and priority under 35 U.S.C. § 119(e) to U.S. Provisional Patent Application No. 63/269,534 entitled “Systems and Methods for Software Simulation of Brain-Machine Interfaces” filed Mar. 17, 2022. The disclosure of U.S. Provisional Patent Application No. 63/269,534 is hereby incorporated by reference in its entirety for all purposes.

### GOVERNMENT FUNDING STATEMENT

This invention was made with government support under Grant Number NS121097, awarded by the National Institutes of Health. The government has certain rights in the invention.

### FIELD OF THE INVENTION

The present invention generally relates to in silico simulation of brain-machine interfaces (BCIs).

### BACKGROUND

Brain-Computer Interfaces (BCIs, also referred to as Brain-Machine Interfaces or BMIs) are devices which translate neural activity into control signals for prosthetic devices (including, but not limited to, digital prosthetic devices such as computer avatars and cursors). Intracortical BCIs are BCIs which use implanted electrodes to record neural activity in a patient. Different intracortical recording modalities provide significantly different types of neural signals. Example intracortical recording modalities include electrocorticograms (ECoGs) which records using macroelectrodes on the surface of the brain to record the average activity of a large number of electrodes, and microelectrode arrays (such as the Utah Array) which are implanted into the tissue of the brain and record the activity of individual or small groups of neurons. Depending on the recording modality, the types of neural signals received may be at significantly different spatial and/or temporal resolutions.

### SUMMARY OF THE INVENTION

Systems and methods for simulating brain-machine interfaces in accordance with embodiments of the invention are illustrated. One embodiment includes a method for evaluating brain-computer interface (BCI) decoders in silico, comprising obtaining a BCI decoder, generating a set of neural signals using a neural encoder, providing the set of neural signals to the BCI decoder, receiving a command from the BCI decoder based on the set of neural signals, simulating the command in a simulated environment using an environmental simulator, providing an environmental state of the simulated environment from the environmental simulator to an artificial intelligence (AI) agent, generating an intended action using the AI agent based on the environmental state, providing the intended action to the neural encoder, continuously, until a predefined break point has been reached producing an updated set of neural signals using the neural encoder, providing the updated set of neural signals to the BCI decoder, receiving an updated command from the BCI decoder based on the updated set of neural signals, simulating the updated command in a simulated environment using the environmental simulator, providing an updated environmental state of the simulated environment from the environmental simulator to the AI agent, generating an updated intended action using the AI agent based on the environmental state, and providing the updated intended action to the neural encoder for use in producing the updated set of neural signals, and providing a record of evaluation metrics based on performance of the BCI decoder.

In a further embodiment, the predefined breakpoint is completion of a task in the simulated environment.

In still another embodiment, the predefined breakpoint is a predefined number of iterations.

In a still further embodiment, the AI agent is a reinforcement learning model.

In yet another embodiment, the reinforcement learning model includes proximal policy optimization incorporating a smoothness constraint that penalizes Kullback-Leibler divergence on consecutive actions.

In a yet further embodiment, the reinforcement learning model includes proximal policy optimization incorporating a zeroness constraint that penalizes Kullback-Leibler divergence of each action close to a Gaussian distribution with zero mean and unit variance.

In another additional embodiment, the record of evaluation metrics includes at least one of a number of iterations, an iteration at which a task was completed in the simulated environment, BCI decoder performance, BCI decoder accuracy, BCI decoder precision, and number of iterations to train the AI agent to perform at a predetermined level.

One embodiment includes a system for evaluating brain-computer interface (BCI) decoders in silico, comprising a processor, and a memory, the memory containing a BCI simulation application that configures the processor to obtain a BCI decoder, generate a set of neural signals using a neural encoder, provide the set of neural signals to the BCI decoder, receive a command from the BCI decoder based on the set of neural signals, simulate the command in a simulated environment using an environmental simulator, provide an environmental state of the simulated environment from the environmental simulator to an artificial intelligence (AI) agent, generate an intended action using the AI agent based on the environmental state, provide the intended action to the neural encoder, continuously, until a predefined break point has been reached produce an updated set of neural signals using the neural encoder, provide the updated set of neural signals to the BCI decoder, receive an updated command from the BCI decoder based on the updated set of neural signals, simulate the updated command in a simulated environment using the environmental simulator, provide an updated environmental state of the simulated environment from the environmental simulator to the AI agent, generate an updated intended action using the AI agent based on the environmental state, and provide the updated intended action to the neural encoder for use in producing the updated set of neural signals, and provide a record of evaluation metrics based on performance of the BCI decoder.

In a further additional embodiment, the predefined breakpoint is completion of a task in the simulated environment.

In another embodiment again, the predefined breakpoint is a predefined number of iterations.

In a further embodiment again, the AI agent is a reinforcement learning model.

In still yet another embodiment, the reinforcement learning model includes proximal policy optimization incorporating a smoothness constraint that penalizes Kullback-Leibler divergence on consecutive actions.

In a still yet further embodiment, the reinforcement learning model includes proximal policy optimization incorporating a zeroness constraint that penalizes Kullback-Leibler divergence of each action close to a Gaussian distribution with zero mean and unit variance.

In still another additional embodiment, the record of evaluation metrics includes at least one of a number of iterations, an iteration at which a task was completed in the simulated environment, BCI decoder performance, BCI decoder accuracy, BCI decoder precision, and number of iterations to train the AI agent to perform at a predetermined level.

One embodiment includes a brain-computer interface (BCI), comprising several electrodes configured to record neural signals from a brain, and a BCI decoder configured to translate recorded neural signals into commands, where the BCI decoder is evaluated by generating a set of synthetic neural signals using a neural encoder, providing the set of synthetic neural signals to the BCI decoder, receiving a command from the BCI decoder based on the set of synthetic neural signals, simulating the command in a simulated environment using an environmental simulator, providing an environmental state of the simulated environment from the environmental simulator to an artificial intelligence (AI) agent, generating an intended action using the AI agent based on the environmental state, providing the intended action to the neural encoder, continuously, until a predefined break point has been reached producing an updated set of synthetic neural signals using the neural encoder, providing the updated set of synthetic neural signals to the BCI decoder, receiving an updated command from the BCI decoder based on the updated set of synthetic neural signals, simulating the updated command in a simulated environment using the environmental simulator, providing an updated environmental state of the simulated environment from the environmental simulator to the AI agent, generating an updated intended action using the AI agent based on the environmental state, and providing the updated intended action to the neural encoder for use in producing the updated set of synthetic neural signals.

In a still further additional embodiment, the predefined breakpoint is completion of a task in the simulated environment.

In still another embodiment again, the predefined breakpoint is a predefined number of iterations.

In a still further embodiment again, the AI agent is a reinforcement learning model with proximal policy optimization incorporating a smoothness constraint that penalizes Kullback-Leibler divergence on consecutive actions.

In yet another additional embodiment, the AI agent is a reinforcement learning model with proximal policy optimization incorporating a zeroness constraint that penalizes Kullback-Leibler divergence of each action close to a Gaussian distribution with zero mean and unit variance.

In a yet further additional embodiment, the record of evaluation metrics includes at least one of a number of iterations, an iteration at which a task was completed in the simulated environment, BCI decoder performance, BCI decoder accuracy, BCI decoder precision, and number of iterations to train the AI agent to perform at a predetermined level.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a system diagram for a BCI simulator in accordance with an embodiment of the invention.

FIG. 2 is a block diagram for a BCI simulator implemented on a single computing platform in accordance with an embodiment of the invention.

FIG. 3 is a flow chart for a BCI simulation process in accordance with an embodiment of the invention.

### DETAILED DESCRIPTION

Systems and methods for recognizing software simulation of brain-machine interfaces in accordance with embodiments of the invention are disclosed. Intracortical brain-computer interfaces (BCIs) have remained in pilot clinical trials since 2004, not yet reaching clinical viability. A key reason for this slow development is a lack of technology that enables larger communities to design and optimize BCIs. Currently, BCIs are designed and tested in animals and humans, which can slow down the design process. Systems and methods described herein provide a computational framework for simulating BCIs, enabling rapid prototyping. Simulators as described here in accordance with embodiments of the invention can provide fast and accurate optimization for multi-degree of freedom (DoF) BCI decoders.

A key challenge is that BCIs are closed-loop systems: BCIs decode neural activity into movements imperfectly, and so a user must make new motor commands in response to feedback of these imperfect BCI decodes. Therefore, the performance of a BCI relies on how the user interacts with an imperfect decoder. That is, a user must constantly adjust their motor commands in response to feedback of the decoded output. This conscious and/or unconscious modification of motor commands (realized as neural activity from intention) for a given user is referred to as the “control policy.” It is well-documented that decoder optimization on previously collected data (“open loop” optimization) may lead to incorrect conclusions because they do not account for this closed-loop control. As such, BCI research is traditionally based on macaque or human experiments, where users adjust and learn to optimally control a real-time BCI. These experiments require long experimental times, making research far slower and only accessible to few laboratories. Every time a new decoder is tested, the user must adjust and learn again to “update” their control policy for the new decoder. In contrast, aspects of certain embodiments can be implemented entirely in software, do not require physical laboratory experiments, and provide rapid optimization of new BCI decoders as control policies for any arbitrary decoder can be rapidly trained and used in closed-loop performance testing.

To do so, embodiments can utilize deep learning (DL) techniques to simulate realistic neural activity and replace the human-in-the-loop with a human-like artificial intelligence (AI) agent. Specifically, a simulator in accordance with embodiments of the invention can incorporate DL “neural encoders” that accurately simulate neural activity. Second, embodiments may use nonlinear neural networks, combined with deep reinforcement learning (RL) with novel behavioral constraints to train an AI agent to interact and control new decoder algorithms (RL training) under the constraint that they behave like a human. In this fashion, an AI agent interacts with a simulated BCI decoder.

Importantly, results demonstrate that the AI simulation is accurate to reproduce the results of previously reported monkey experiments that took months to years to perform. An AI agent in accordance with embodiments of the invention, after training, can achieve the same conclusions in a matter of seconds, rapidly accelerating the development of BCI decoder algorithms. The details of the DL “neural encoders” that may be utilized in accordance with embodiments of the invention can be found in Liang K-F, Kao J C. Deep Learning Neural Encoders for Motor Cortex. IEEE Trans Biomed Eng. 2020; 67:2145-2158, the which is incorporated by reference in their entirety. However, any number of different models which can produce neural signals based on kinematic inputs can be used as appropriate to the requirements of specific applications of embodiments of the invention.

In many embodiments, the AI agent simulates the human/animal brain in the BCI brain-machine relationship. In various embodiments, the AI agent is implemented as a deep nonlinear neural network as opposed to a linear implementation which may fail in complex control scenarios. The AI agent is trained using deep reinforcement learning to process “observations” from which it then generates “actions” for a particular task. A fully closed-loop training environment can be constructed whereby a neural encoder is used to generate synthetic neural signals which are passed to a BCI decoder, which in turn produces decoded results that are acted out in a simulated environment. Feedback from the changed simulated environment state is provided to the AI agent which acts as a control policy and outputs an action to be taken, which then can be converted into new synthetic neural signals using the neural encoder again. Over numerous iterations, the AI agent can be trained to better control any given decoder. Using this framework, different decoders can be tested entirely in silico without the need for a human or animal experimentation and invasive surgeries. BCI simulation systems are discussed in further detail below.

### BCI Simulation Systems

BCI simulation systems use AI agents to replace animal control policies in order to accelerate testing of BCI decoders. Neural encoders are used in conjunction with the AI agents to completely simulate a human/animal test subject. The AI agent has access to observations of a simulated task environment which it can interact with using the BCI decoder. In this way, the BCI decoder can be tested in any of a number of different ways. For example, the number of iterations for a working control policy to be learned may indicate how easy it will be for a human user to use a given BCI decoder, expose flaws in the BCI decoder, and/or uncover any other aspect of a particular BCI decoder implementation. In some situations, a BCI decoder may simply fail at a given task, or perform too poorly to consider deployment. In any circumstance, investigation of a particular BCI decoder can be undertaken without the need for live subjects.

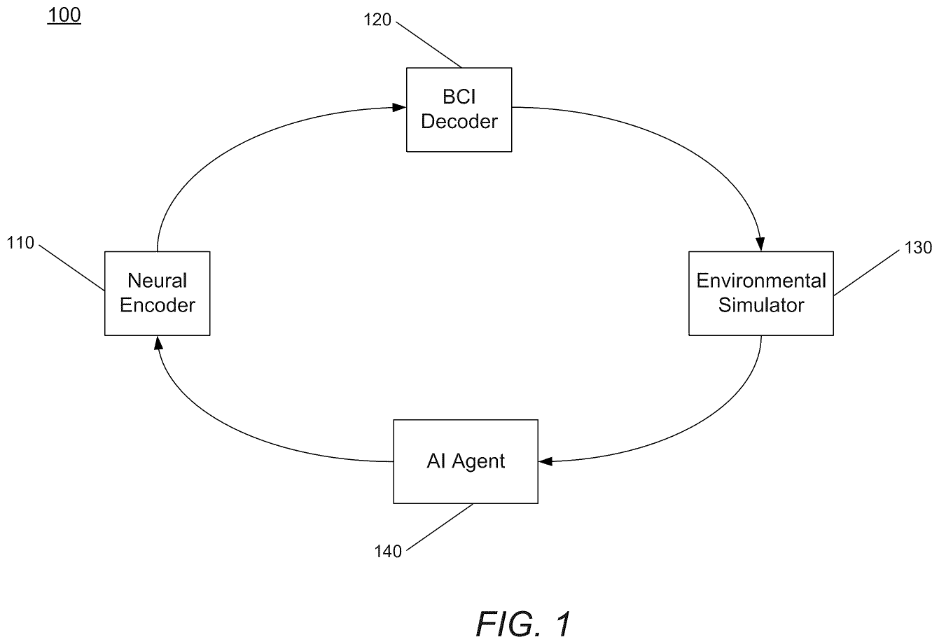

Turning now to FIG. 1, a BCI simulation system in accordance with an embodiment of the invention is illustrated. Simulation system 100 includes a neural encoder 110. Neural encoders are models which map motor commands to synthetic neural activity. While it may appear challenging to generate synthetic neural activity that could be successfully used for BCI simulation, properties of motor cortical activity significantly simplify the problem. In particular, motor cortical population activity is relatively low-dimensional, exhibits structured dynamics, and can be reasonably modeled using recursive neural networks (RNNs) in tasks with simple inputs. If more complex inputs are needed (either for tasks that cannot be decomposed, or to enhance user options), more complicated neural networks can be utilized as appropriate to the requirements of specific applications of embodiments of the invention.

In numerous embodiments, neural encoders are RNNs trained to transform kinematic inputs to binned spike outputs. Training can be achieved using datasets of neural encoder spike outputs correlated with real-user recorded motor activity. In various embodiments, a delay between kinematics and neural activity is introduced during training, and/or RNN input weights are regularized in order to better reproduce the dynamics of neural population recordings. However, any number of different neural encoders can be used as appropriate to the requirements of specific applications of embodiments of the invention.

System 100 further includes a BCI decoder 120. BCI decoders are models which convert neural signals into commands. BCI decoders in system 100 can be swapped out so that different decoder implementations can be tested. In various embodiments, BCI decoders are task-specific. The BCI decoder is connected to an environmental simulator 130. Environmental simulators provide an environment in which intended actions are performed. The environment can be virtual, real-world, or a combination thereof. In various embodiments, the environmental simulator simulates a real-world environment such as a prosthetic device. In numerous embodiments, the environment is a computer interface which contains a cursor that is controlled by the BCI decoder. As can readily be appreciated, the environmental simulator can be modified to simulate any number of different scenarios depending on the particular BCI decoder that is being tested. The environmental simulator contains prosthetics or other virtual objects and/or functionalities that are controlled by the BCI decoder.

The environmental simulator can provide data describing its current state (an “observation”) to an AI agent 140. The AI agent observes the state of the environment and produces an intended action. In numerous embodiments, the intended action is a kinematic motor action which is provided in turn to the neural encoder 110. As noted above, AI agents generate actions with a control policy which can be trained by using reinforcement learning (RL). In numerous embodiment, the AI agent is implemented as a nonlinear control policy using deep reinforcement learning (RL) with proximal policy optimization, an actor critic method. AI Agents are constrained to make movements similar to how a human might control a BCI. Because any arbitrary decoder can be tested, and because control policies can radically differ between different BCI decoders, imitation learning may not be sufficient in many circumstances. Reinforcement learning can incorporate Kullback-Leibler (KL) divergence constraints to train the agent in a way that enforces action smoothness and energy conservation.

In many embodiments, to train a deep RL neural network, proximal policy optimization (PPO) is used with regularizations to encourage human-like behavior. PPO uses a clipped surrogate objective function with a goal of reducing KL divergence between successive gradient updates. To encourage exploration, the entropy of actions given state can be added to the objective function. The loss function of PPO is defined as:

$${ℒ}_{PPO} = 𝔼 [ min ( {r}_{t} ( θ ) {\hat{A}}_{t} , clip ( {r}_{t} ( θ ) , 1 - ε , 1 + ε ) {\hat{A}}_{t} ] + β H ( {π}_{θ} ( \cdot \vert {s}_{t} ) )$$

$${r}_{t} ( θ ) = \frac{{π}_{θ} ( {a}_{t} \vert {s}_{t} )}{{π}_{{θ}_{o l d}} ( {a}_{t} \vert {s}_{t} )}$$

$${\hat{A}}_{t} = {\sum }_{l = 0}^{∞} {( γ λ )}^{l} {δ}_{t + 1}^{V}$$

$${δ}_{t}^{V} = {R}_{t} + γ V ( {s}_{t + 1} ) - V ( {s}_{t} ) ,$$

where rₜ is the probability ratio, Âₜ is the advantage value, Rₜ is the reward from environment, V(sₜ) is the output from the value function given sₜ, and γ and λ are hyperparameters in generalized advantage estimation. PPO updates can be performed with first-order stochastic gradient descent or Adam. AI agent outputs can be implemented as means and standard deviations of Gaussian distributions modeling the stochastic actions. The PPO algorithm can include a policy and a value network. The policy network can be implemented as a feedforward neural network having affine layers and an activation function followed by a linear layer to provide the above outputs. The value network can have the same affine layers as the policy network followed by a linear layer to estimate the value function V(sₜ).

In order to force the PPO to behave like a human, two additional regularization terms can be added: 1) a smoothness constraint that penalizes KL divergence on consecutive actions; and 2) a zeroness constraint that penalizes KL divergence of each action close to a Gaussian distribution with zero mean and unit variance. The resulting objective function of the constrained PPO agent is:

$$ℒ = {ℒ}_{PPO} + {α}_{smoothness} K L ( ( \cdot \vert {s}_{t} ) \vert \vert ( \cdot \vert {s}_{t + 1} ) ) + {α}_{zeroness} K L ( ( \cdot \vert {s}_{t} ) ‖ Gaussian ( 0 , 1 ) )$$

In numerous embodiments, the agent can be trained using curriculum learning.

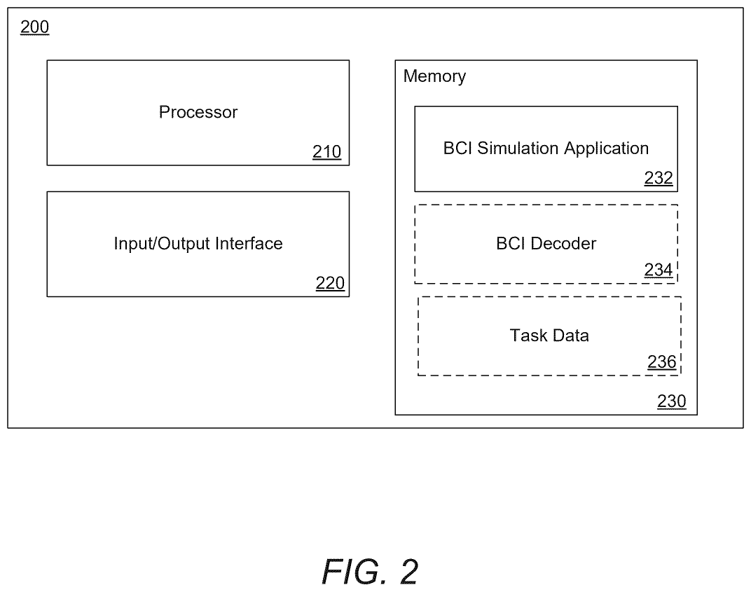

While a particular agent implementation is described above, as can readily be appreciated, alternative machine learning models may be used to achieve similar functionality without departing from the scope or spirit of the invention. A model which sufficiently implements a human-like control policy is sufficient to function in a BCI simulation system as described herein. Turning now to FIG. 2, a block diagram for a computing platform implementing a BCI simulation system in accordance with an embodiment of the invention is illustrated.

BCI simulator 200 includes a processor 210. Processors can be any number of one or more types of logic processing circuits including (but not limited to) central processing units (CPUs), graphics processing units (GPUs), field-programmable gate arrays (FPGAs), application-specific integrated circuits (ASICs), and/or any other logic circuit capable of carrying out symbol decoding processes as appropriate to the requirements of specific applications of embodiments of the invention.

The BCI simulator 200 further includes an input/output (I/O) interface 220. In numerous embodiments, I/O interfaces are capable of obtaining data from neural signal recorders. In various embodiments, I/O interfaces are capable of communicating with output devices and/or other computing devices. The BCI simulator 200 further includes a memory 230. The memory can be volatile memory, non-volatile memory, or any combination thereof. The memory 230 contains a BCI simulation application 232. The symbol decoding application is capable of directing at least the processor to perform various BCI simulation processes such as (but not limited to) those described herein. The memory variously can contain a BCI decoder 234 for testing, and/or task data 236 which describes the environment to be simulated, any objects which are to be controlled in the environment, as well as any other information needed to instantiate a simulated environment for testing.

As can be readily appreciated, while FIG. 2 illustrates an implementation of a BCI simulator on a single computing platform, any number of distributed computing architectures can be used without departing from the scope or spirit of the invention. Further, while in many embodiments BCI simulation applications may implement neural encoders, environmental simulators, AI agents, and/or BCI decoders, different applications can be used to split these functionalities into separate executable applications. BCI simulation processes are discussed in additional detail below.

### BCI Simulation

As discussed above, BCI simulation processes utilize neural encoders to simulate neural activity, and AI agents to simulate a user's control policy. These two components replace the live subject in a testing environment. In many embodiments, the neural encoder is trained before testing using recordings of real neural activity associated with particular intended motor movements. In various embodiments, the AI agent is pretrained at least to some degree. AI agents can be trained (or additionally trained) during the testing process to generate a control policy appropriate to any arbitrary BCI decoder that is being used for testing. Metrics including (but not limited to) BCI decoder performance, BCI decoder accuracy, BCI decoder precision, AI agent performance, time to train the AI agent to a predetermined performance threshold, and/or any other metric can be recorded and used to evaluate BCI performance during or after simulation.

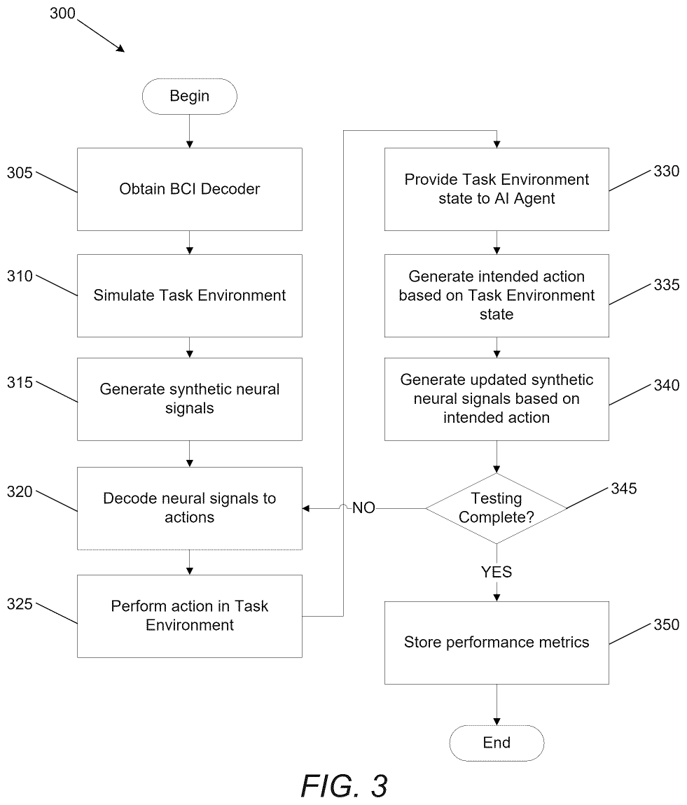

Turning now to FIG. 3, a process for BCI simulation in accordance with an embodiment of the invention is illustrated. Process 300 includes obtaining (305) a BCI decoder for testing. As previously noted, control policies for different BCI decoders tend to be significantly different. A task environment is simulated (310) using an environmental simulator, and synthetic neural signals are generated (315) using a neural encoder. The neural signals are decoded (320) into actions by the BCI decoder, and the decoded actions are performed (325) in the simulated environment. The state of the task environment is provided (330) to an AI agent which generates (335) an intended next action based on the current state. The intended action is provided to the neural encoder and used to generate (340) a new set of synthetic neural signals. If the testing process is not complete (345), the updated synthetic neural signals are provided to the BCI decoder and the testing loop continues until the testing is determined to be complete.

In many embodiments, testing is complete once the task has been successfully performed, although different halting parameters can be included such as (but not limited to) failure to perform the task to completion within a certain number of cycles. Once testing is completed, performance metrics are stored (350). As can be readily appreciated, the break point for determining completion of testing can occur at any number of points in the loop depending on the particular needs of a given simulation as appropriate to the requirements of specific applications of embodiments of the invention.

Although the description above contains many specificities, these should not be construed as limiting the scope of the invention but as merely providing illustrations of some of the presently preferred embodiments of the invention. Various other embodiments are possible within its scope. Accordingly, the scope of the invention should be determined not by the embodiments illustrated, but by the claims and their equivalents.

What is claimed is:

1. A method for evaluating brain-computer interface (BCI) decoders in silico, comprising:
obtaining a BCI decoder,
generating a set of neural signals using a neural encoder;
providing the set of neural signals to the BCI decoder;
receiving a command from the BCI decoder based on the set of neural signals;
simulating the command in a simulated environment using an environmental simulator;
providing an environmental state of the simulated environment from the environmental simulator to an artificial intelligence (AI) agent;
generating an intended action using the AI agent based on the environmental state;
providing the intended action to the neural encoder;
continuously, until a predefined break point has been reached:
producing an updated set of neural signals using the neural encoder;
providing the updated set of neural signals to the BCI decoder;
receiving an updated command from the BCI decoder based on the updated set of neural signals;
simulating the updated command in a simulated environment using the environmental simulator;
providing an updated environmental state of the simulated environment from the environmental simulator to the AI agent;
generating an updated intended action using the AI agent based on the environmental state; and
providing the updated intended action to the neural encoder for use in producing the updated set of neural signals; and
providing a record of evaluation metrics based on performance of the BCI decoder.

2. The method for evaluating BCI decoders in silico of claim 1, wherein the predefined breakpoint is completion of a task in the simulated environment.

3. The method for evaluating BCI decoders in silico of claim 1, wherein the predefined breakpoint is a predefined number of iterations.

4. The method for evaluating BCI decoders in silico of claim 1, wherein the AI agent is a reinforcement learning model.

5. The method for evaluating BCI decoders in silico of claim 4, wherein the reinforcement learning model comprises proximal policy optimization incorporating a smoothness constraint that penalizes Kullback-Leibler divergence on consecutive actions.

6. The method for evaluating BCI decoders in silico of claim 4, wherein the reinforcement learning model comprises proximal policy optimization incorporating a zeroness constraint that penalizes Kullback-Leibler divergence of each action close to a Gaussian distribution with zero mean and unit variance.

7. The method for evaluating BCI decoders in silico of claim 1, wherein the record of evaluation metrics comprises at least one of: a number of iterations; an iteration at which a task was completed in the simulated environment; BCI decoder performance, BCI decoder accuracy, BCI decoder precision, and number of iterations to train the AI agent to perform at a predetermined level.

8. A system for evaluating brain-computer interface (BCI) decoders in silico, comprising:
a processor; and
a memory, the memory containing a BCI simulation application that configures the processor to:
obtain a BCI decoder,
generate a set of neural signals using a neural encoder;
provide the set of neural signals to the BCI decoder;
receive a command from the BCI decoder based on the set of neural signals;
simulate the command in a simulated environment using an environmental simulator;
provide an environmental state of the simulated environment from the environmental simulator to an artificial intelligence (AI) agent;
generate an intended action using the AI agent based on the environmental state;
provide the intended action to the neural encoder;
continuously, until a predefined break point has been reached:
produce an updated set of neural signals using the neural encoder;
provide the updated set of neural signals to the BCI decoder;
receive an updated command from the BCI decoder based on the updated set of neural signals;
simulate the updated command in a simulated environment using the environmental simulator;
provide an updated environmental state of the simulated environment from the environmental simulator to the AI agent;
generate an updated intended action using the AI agent based on the environmental state; and
provide the updated intended action to the neural encoder for use in producing the updated set of neural signals; and
provide a record of evaluation metrics based on performance of the BCI decoder.

9. The system for evaluating BCI decoders in silico of claim 8, wherein the predefined breakpoint is completion of a task in the simulated environment.

10. The system for evaluating BCI decoders in silico of claim 8, wherein the predefined breakpoint is a predefined number of iterations.

11. The system for evaluating BCI decoders in silico of claim 8, wherein the AI agent is a reinforcement learning model.

12. The system for evaluating BCI decoders in silico of claim 11, wherein the reinforcement learning model comprises proximal policy optimization incorporating a smoothness constraint that penalizes Kullback-Leibler divergence on consecutive actions.

13. The system for evaluating BCI decoders in silico of claim 11, wherein the reinforcement learning model comprises proximal policy optimization incorporating a zeroness constraint that penalizes Kullback-Leibler divergence of each action close to a Gaussian distribution with zero mean and unit variance.

14. The system for evaluating BCI decoders in silico of claim 8, wherein the record of evaluation metrics comprises at least one of: a number of iterations; an iteration at which a task was completed in the simulated environment; BCI decoder performance, BCI decoder accuracy, BCI decoder precision, and number of iterations to train the AI agent to perform at a predetermined level.

15. A brain-computer interface (BCI), comprising:
a plurality of electrodes configured to record neural signals from a brain; and
a BCI decoder configured to translate recorded neural signals into commands, where the BCI decoder is evaluated by:
generating a set of synthetic neural signals using a neural encoder;
providing the set of synthetic neural signals to the BCI decoder;
receiving a command from the BCI decoder based on the set of synthetic neural signals;
simulating the command in a simulated environment using an environmental simulator;
providing an environmental state of the simulated environment from the environmental simulator to an artificial intelligence (AI) agent;
generating an intended action using the AI agent based on the environmental state;
providing the intended action to the neural encoder;
continuously, until a predefined break point has been reached:
producing an updated set of synthetic neural signals using the neural encoder;
providing the updated set of synthetic neural signals to the BCI decoder;
receiving an updated command from the BCI decoder based on the updated set of synthetic neural signals;
simulating the updated command in a simulated environment using the environmental simulator;
providing an updated environmental state of the simulated environment from the environmental simulator to the AI agent;
generating an updated intended action using the AI agent based on the environmental state; and
providing the updated intended action to the neural encoder for use in producing the updated set of synthetic neural signals.

16. The system for evaluating BCI decoders in silico of claim 15, wherein the predefined breakpoint is completion of a task in the simulated environment.

17. The system for evaluating BCI decoders in silico of claim 15, wherein the predefined breakpoint is a predefined number of iterations.

18. The system for evaluating BCI decoders in silico of claim 15, wherein the AI agent is a reinforcement learning model with proximal policy optimization incorporating a smoothness constraint that penalizes Kullback-Leibler divergence on consecutive actions.

19. The system for evaluating BCI decoders in silico of claim 15, wherein the AI agent is a reinforcement learning model with proximal policy optimization incorporating a zeroness constraint that penalizes Kullback-Leibler divergence of each action close to a Gaussian distribution with zero mean and unit variance.

20. The system for evaluating BCI decoders in silico of claim 15, wherein the record of evaluation metrics comprises at least one of: a number of iterations; an iteration at which a task was completed in the simulated environment; BCI decoder performance, BCI decoder accuracy, BCI decoder precision, and number of iterations to train the AI agent to perform at a predetermined level.
